(19) United States
(12) Patent Application Publication
(10) Pub. No.: US 2013/0181953 A1
(43) Pub. Date: Jul. 18, 2013

(54) STYLUS COMPUTING ENVIRONMENT

(71) Applicants: Kenneth P. Hinckley, Redmond, WA (US); Stephen G. Latta, Seattle, WA (US)

(72) Inventors: Kenneth P. Hinckley, Redmond, WA (US); Stephen G. Latta, Seattle, WA (US)

(73) Assignee: MICROSOFT CORPORATION, Redmond, WA (US)

(21) Appl. No.: 13/350,540

(22) Filed: Jan. 13, 2012

(51) Int. Cl. G06F 3/033

(52) U.S. Cl. 345/179

(57) ABSTRACT

A stylus computing environment is described. In one or more implementations, one or more inputs are detected using one or more sensors of a stylus. A user that has grasped the stylus, using fingers of the user's hand, is identified from the received one or more inputs. One or more actions are performed based on the identification of the user that was performed using the one or more inputs received from the one or more sensors of the stylus

### BACKGROUND

The number of computing devices with which even a typical user may interact in a given day is ever increasing. A user, for instance, may interact with a home computer, mobile phone, tablet computer, multiple work computers, and so on. Consequently, a user's efficiency in interacting with each of these devices may decrease as more computing devices are added.

For example, current use of identity by these devices may be inefficient. Using conventional techniques, for instance, a user may provide a user name and password to login to each of these devices. If the user chooses to forgo such a login, data in the device may become compromised by a malicious party. Therefore, the user may be forced to engage in this login procedure if the data is deemed even somewhat important, e.g., such as contact data that may be used by malicious parties to compromise an identity of the user. In another example, a user's interaction with the different devices may become fractured as different interactions are performed with the different devices. Thus, conventional techniques to identify a user for these different devices may become burdensome to the user.

### SUMMARY

A stylus computing environment is described. In one or more implementations, one or more inputs are detected using one or more sensors of a stylus. A user that has grasped the stylus, using fingers of the user's hand, is identified from the received one or more inputs. One or more actions are performed based on the identification of the user that was performed using the one or more inputs received from the one or more sensors of the stylus

In one or more implementations, a stylus includes a housing configured to be graspable using fingers of a user's hand, one or more sensors, and one or more modules disposed within the housing and implemented at least partially in hardware and configured to process data obtained from the one or more sensors to identify the user and provide an output indicating the identification of the user.

In one or more implementations, a user is logged into a first computing device using information captured by one or more sensors of a stylus. Information is stored at a network service, the information describing a current state of a user's interaction with one or more applications executed at a first computing device. The user is logged into a second computing device using information captured by the one or more sensors of the stylus. Responsive to the logging in at the second computing device, the information is obtained by the second computing device from the network service that describes the user's interaction with the first computing device and one or more applications executed at the second computing device are configured to the current state of the user's interaction as described by the stored information.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ stylus computing environment techniques.

FIG. 2 illustrates an example system showing a stylus of FIG. 1 in greater detail.

FIG. 3 depicts a system in an example implementation in which a stylus is used to support a computing environment that is executable using different devices.

FIG. 4 is a flow diagram depicting a procedure in an example implementation in which a user is identified using a stylus.

FIG. 5 is a flow diagram depicting a procedure in an example implementation in which a network service is leveraged using a stylus to provide a continued computing environment.

FIG. 6 illustrates an example system that includes the computing device as described with reference to FIG. 1.

FIG. 7 illustrates various components of an example device that can be implemented as any type of portable and/or computer device as described with reference to FIGS. 1-3 and 6 to implement embodiments of the gesture techniques described herein.

### DETAILED DESCRIPTION

Overview

Conventional use of identity by computing devices is often basic and inefficient. For example, login screens with passwords or PIN codes are the most common identity technique, which are generally time consuming and susceptible to hacking, especially if a user typically interacts with a large number of computing device in a given day.

Stylus computing environment techniques are described herein. In one or more implementations, a stylus may be used to identify a user based on a variety of characteristics of the user. These characteristics may include a fingerprint of one or more fingers of the user's hand, “how” the stylus is held by the user (e.g., which fingers and/or an orientation of the stylus in space or characteristic angles relative to the writing surface), handwriting of the user holding the stylus, and so on. Furthermore, such sensing inputs, once having established identity, may maintain the user in an “identified” state as long as he continues to hold (e.g. maintain skin contact with) the stylus. Thus, identity of the user may be maintained by the stylus across a number of interactions.

This identity may serve as a basis of a variety of actions, such as login the user, launch applications, provide a customized environment, obtain configuration settings particular to the user, obtain a current state of a user's interaction with one device and employ this state on another device, and so on. Thus, these techniques may be used to support a seamless environment between devices and allow a user to efficiently interact with this environment, further discussion of which may be found in relation to the following figures.

In the following discussion, an example environment is first described that is operable to employ the stylus computing environment techniques described herein. Example illustrations of procedures involving the techniques are then described, which may be employed in the example environment as well as in other environments. Accordingly, the example environment is not limited to performing the example procedures. Likewise, the example procedures are not limited to implementation in the example environment.

Example Environment

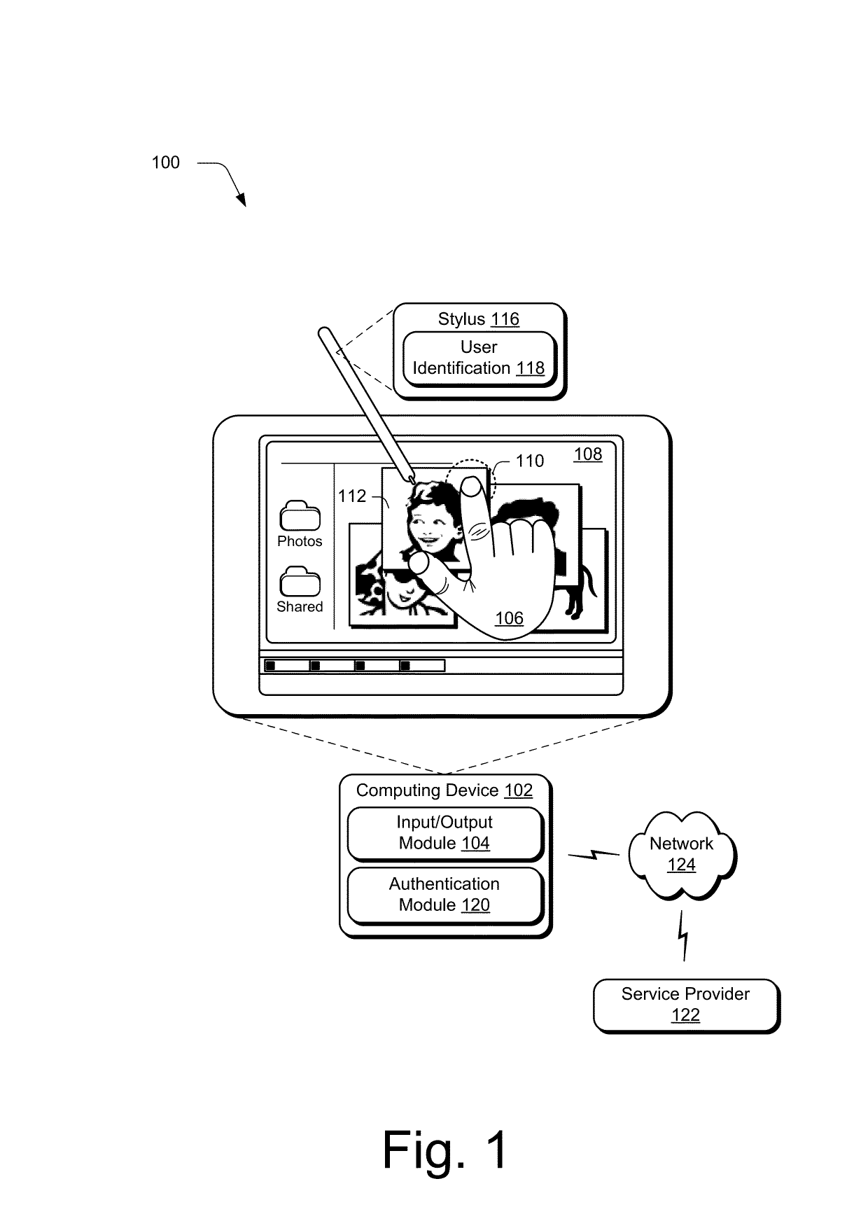

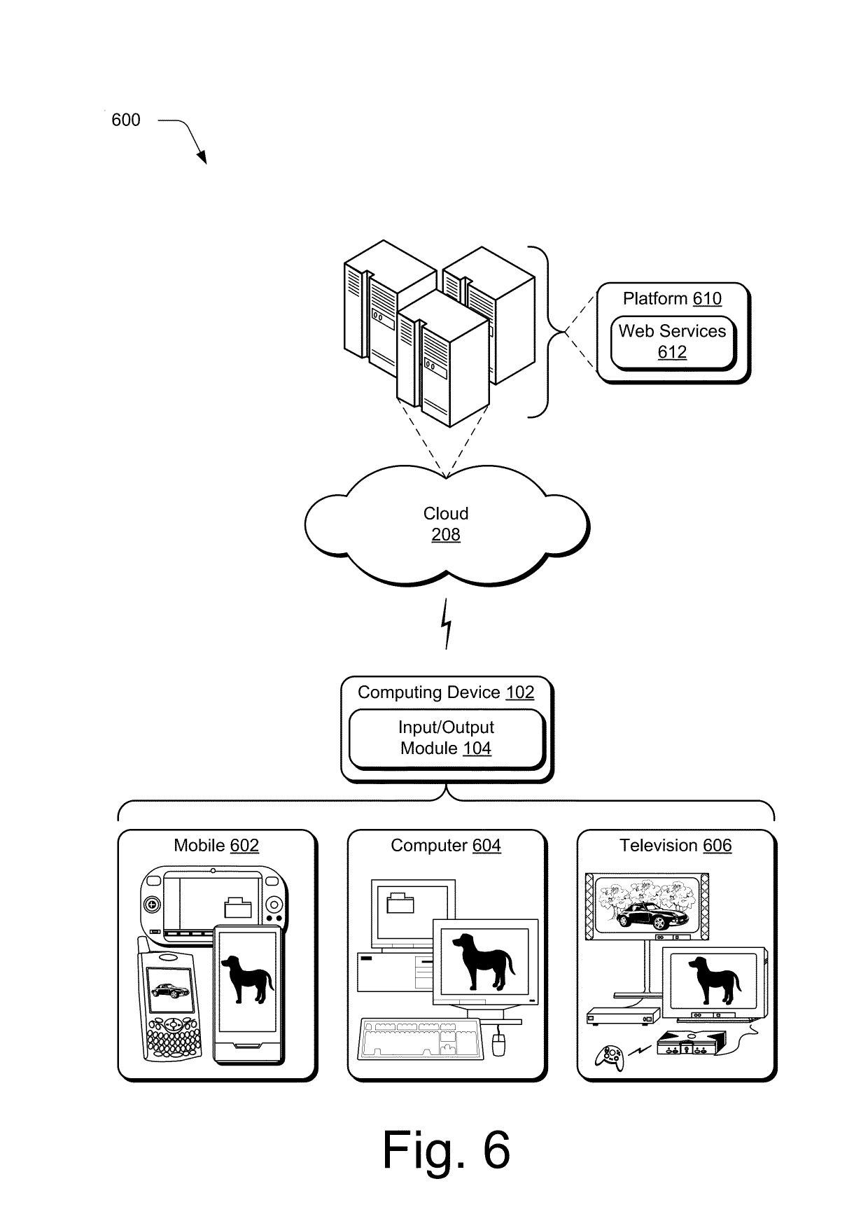

FIG. 1 is an illustration of an environment 100 in an example implementation that is operable to employ stylus computing environment techniques. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, and so forth as further described in relation to FIG. 6. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 may also relate to software that causes the computing device 102 to perform one or more operations.

The computing device 102 is illustrated as including an input/output module 104. The input/output module 104 is representative of functionality to identify inputs and cause operations to be performed that correspond to the inputs. For example, gestures may be identified by the input/output module 104 in a variety of different ways. For example, the input/output module 104 may be configured to recognize a touch input, such as a finger of a user's hand 106 as proximal to a display device 108 of the computing device 102 using touchscreen functionality.

The touch input may also be recognized as including attributes (e.g., movement, selection point, etc.) that are usable to differentiate the touch input from other touch inputs recognized by the input/output module 104. This differentiation may then serve as a basis to identify a gesture from the touch inputs and consequently an operation that is to be performed based on identification of the gesture.

For example, a finger of the user's hand 106 is illustrated as selecting 110 an image 112 displayed by the display device 108. Selection 110 of the image 112 and subsequent movement of the finger of the user's hand 106 may be recognized by the input/output module 104. The input/output module 104 may then identify this recognized movement as indicating a “drag and drop” operation to change a location of the image 112 to a point in the display at which the finger of the user's hand 106 was lifted away from the display device 108. Thus, recognition of the touch input that describes selection of the image, movement of the selection point to another location, and then lifting of the finger of the user's hand 106 may be used to identify a gesture (e.g., drag-and-drop gesture) that is to initiate the drag-and-drop operation.

A variety of different types of gestures may be recognized by the input/output module 104, such a gestures that are recognized from a single type of input (e.g., touch gestures such as the previously described drag-and-drop gesture) as well as gestures involving multiple types of inputs. For example, the computing device 102 may be configured to detect and differentiate between a touch input (e.g., provided by one or more fingers of the user's hand 106) and a stylus input (e.g., provided by a stylus 116).

The stylus 116 may also be used as a basis to support a wide variety of other functionality. For example, the stylus 116 may support techniques that may be used to uniquely identify a user. The stylus 116, for instance, may include a user identification 118 that may be communicated to the computing device 102, such as through radio frequency identification tag (RFID) techniques, near field communication, or other wireless communication techniques. The user identification may then be processed by an authentication module 120, which is representative of functionality to authenticate a user. Although illustrated as part of the computing device 102, this authentication may also be performed in conjunction with one or more network services.

Note here that there are actually three different identities in play: that of the stylus hardware itself, that of the interaction device that a stylus may be sensed on, as well as the user's identity proper. These may be separated for a richer and more robust treatment of stylus-based identification techniques and interactions. For example, one is a globally unique identifier that may be encoded into the pen itself. This may be used to tell the digitizer “which stylus” is being used to interact with a display device, which stylus is located nearby, and so on). This may be a GUID that the user initially registers to tie the stylus to an online account/identity. Henceforth the GUID is a proxy for user identity. This may be fortified with the other techniques noted herein, such as sensing grip and movement angles of the pen to verify that the intended user is holding the stylus as further described below.

The second example involves the identity of the user proper. This is a validated identity that is associated with certain digital rights. The identity of the user and the identifier on the pen may not be the same. For example, a user may give my stylus to a friend to enable the friend to perform a mark-up. If the system can recognize that a valid stylus is being used, but the person holding it is not the owner, then some (limited) operations such as mark-up may still be permitted.

A third example involves implementations where certain combinations of stylus, device (e.g., slate vs. reader vs. another user's slate), and user identity bring up different default settings, user experiences, or sets of digital rights that may be automatically configured by sensing each of these elements. A variety of other examples are also contemplated.

The authentication of the user's identity may be used to perform a variety of different actions. For example, the computing device 102 may be configured to obtain data that is particular to the user, such as data that is local to the computing device 102, stored in the stylus 116, and/or obtained from one or more network services implemented by a service provider 122 for access via a network 124.

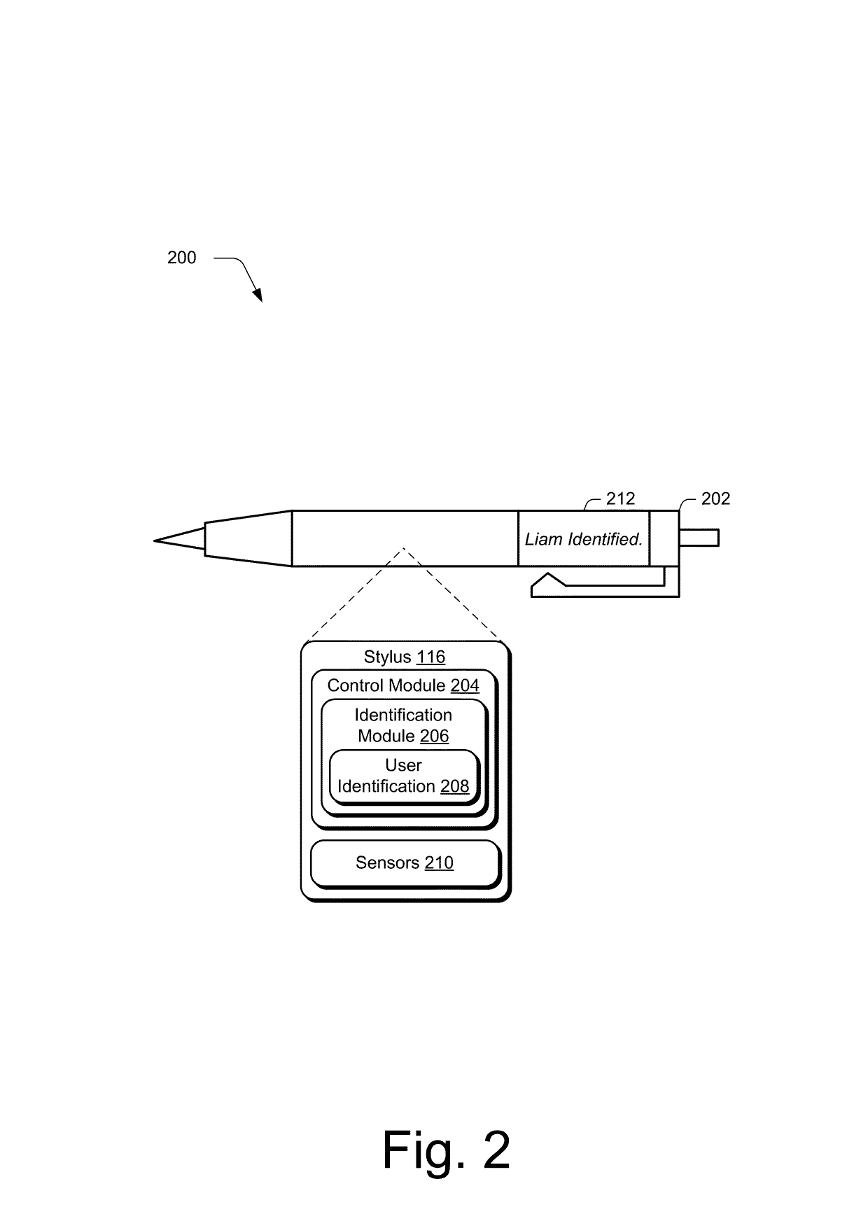

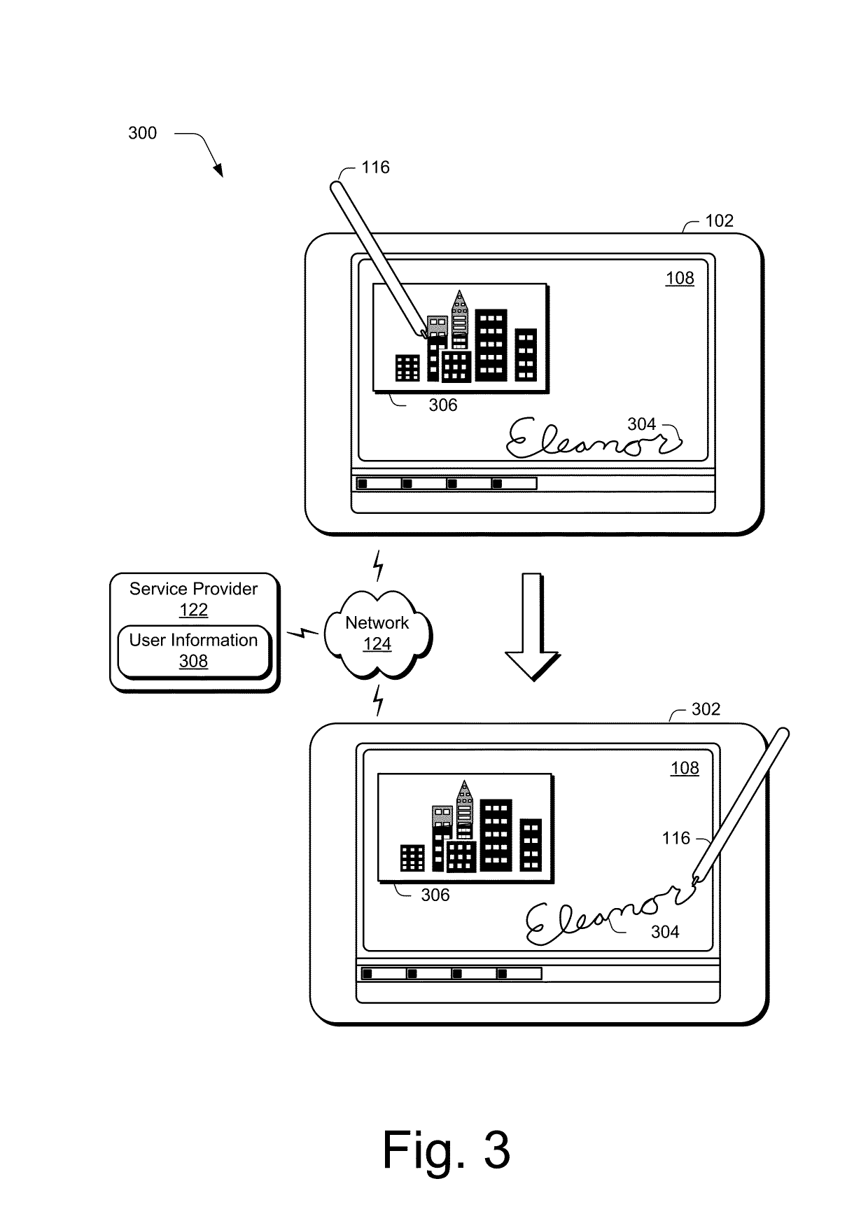

The data may take a variety of forms, such as configuration data to configure a user interface for the particular user, to maintain state across computing devices for the user as further described in relation to FIG. 3, to login the user to the computing device 102, current pen tool mode (e.g. lasso selection mode vs. cut-out tool vs. pen gesture mode vs. inking mode), current pen color and nib (or type of brush/tool) settings, and so on. In the current example, for instance, a user may “get their data anywhere automatically” through use of the techniques described herein. Further discussion of identification of the user through use of the stylus and other examples may be found beginning in relation to FIG. 2.

Although the stylus 116 is described as interacting with a touchscreen device, a variety of other examples are also contemplated. The stylus 116, for instance, may be configured to recognize a pattern (e.g., a matrix of dots) that may be placed on a surface. Therefore, movement of the stylus across the surface may be recognized by the stylus 116 and used as one or more inputs to support user interaction.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the computing device 102 may also include an entity (e.g., software) that causes hardware of the computing device 102 to perform operations, e.g., processors, functional blocks, and so on. For example, the computing device 102 may include a computer-readable medium that may be configured to maintain instructions that cause the computing device, and more particularly hardware of the computing device 102 to perform operations. Thus, the instructions function to configure the hardware to perform the operations and in this way result in transformation of the hardware to perform functions. The instructions may be provided by the computer-readable medium to the computing device 102 through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

FIG. 2 is an illustration of a system 200 showing an example implementation of the stylus 116 in greater detail. In this example, the stylus 116 includes a housing 202. A control module 204 is disposed within the housing and representative of functionality to implement control functionality of the stylus 116. A first example of such functionality is illustrated as an identification module 206 which is representative of functionality of the stylus 116 to assist and/or perform a user identification 208 using one or more sensors 210.

The identification module 206, for instance, may receive data from the sensors 210 and process this data to determine the user identification 218, itself. In another example, the identification module 206 may communicate this data to the computing device 102 (e.g., via near field communication or other wireless network) for processing by the device itself, for communication to a network service via the network 124, and so on.

A variety of different types of data may be collected from the sensors 210, regardless of where and how the identification is performed. For example, the sensors 210 may be configured to detect biometric data of a user that grasps the stylus 116, such as to read one or more fingerprints of the fingers or other parts of the user's hand, temperature, scent, and so on.

In another example, the sensors 210 may be used to detect how the stylus is grasped. For example, the sensors 210 may be disposed across a surface of the housing 202 (e.g., through use of a touch sensitive mesh) and therefore detect which points on the housing 202 are grasped by a user. This may also be combined with an ability to detect which parts of the user are contacting the housing 202 at those points, e.g., through configuration similar to a fingerprint scanner. This information may then be used to aid the identification module 206 in differentiating one user from another.

In a further example, the sensors 210 may be used to determine an orientation of the stylus 116 when held and/or used by a user. The sensors 210, for instance, may include one or more gryoscopes, accelerometers, magnetometers, inertial sensing units, and so on to determine an orientation of the stylus 116 in space, e.g., in a three-dimensional space. This may also be combined with an ability to detect that the stylus 116 is being used (e.g., in conjunction with the computing device 102) and even what the stylus 116 is being used for, e.g., to write, to select a displayed representation on the display device 108, and so on. As before, this data may then be used by the identification module 206 to differentiate one user from another and thus help uniquely identify a user.

A variety of other examples are also contemplated, such as to determine characteristics of a user's handwriting through use of the stylus 116 and thus uniquely identify the user, further discussion of which may be found in relation to FIG. 3. Additionally, implementations are also contemplated in which the sensors 210 are not used to detect the user, e.g., such as to include a unique identifier that identifies the stylus 116 but not necessarily the user of the stylus 116.

A variety of actions may then be taken based on the identification of the user, again regardless of what entity performed the identification and/or how the identification was performed. For example, the user identification 208 may be used to login a user to the computing device 102, such as through identification of the user by the stylus 116 and then communication of the user identification 208 using near field communication to the computing device 102. This may also include communication of the data from the sensors 210 to the computing device 102 for identification of the user at the computing device 102, and so on.

In one or more implementations, the identification may also be used for entry into a vehicle or premises, e.g., a user's car, office, home, and so on and thus may be used for security purposes. Further, communication of the data from and to the stylus may leverage a biological channel. The stylus, for example, may be placed in a user's pocket and communicate data from a sensor through the user (e.g., a user's arm) to a device, such as a car door handle, another computing device, and so on. Thus, the biological channel may reduce an ability of a malicious party to compromise data being communicated through the channel.

In another example, the identification may be used to track and indicate which inputs were provided by which users. For instance, a plurality of users may each interact with a single computing device 102 together, with each user having a respective stylus 116. The computing device 102 may track which inputs were provided by which users, which may be used to support a variety of different functionality. This functionality may include an indication of “who provided what,” support different displays of inputs for different users (e.g., make the inputs “look different”), and so on.

Thus, in some embodiments, “logging in” might be performed as a lightweight operation that is largely invisible to the user. For example, techniques may be employed to simply tag pen strokes as being produced by a specific user with a specific pen (e.g. on a digital whiteboard with multiple users contributing to a list of ideas), to apply proper pen and user profile settings, to migrate pen mode settings across devices, and so forth.

As previously described, the stylus may be leverage to configure a computing device to a current state of a user's interaction with another computing device using stored information. The stylus may also be used to progress a task, workflow, or interaction sequence to the next logical task given the previous steps that were performed on one or more preceding devices. For example, a user may employ the stylus to send a document from a slate to a wall display. When the document appears on the wall display and the user approaches the wall display with the stylus, the document may be automatically opened to start a whiteboard session on top of that document, pulling out pieces of it, and so on. Thus, the next step of the workflow may be made dependent on the specific device to which the user moves, e.g. the next step might depend on whether the user moves to a tabletop, e-reader, wallboard, another user's tablet, a specific tablet that the user may have used before in the context of a specific project, and so forth.

In a further example, feedback may be output on a display device 212 of the stylus 116, itself. The display device 212, for instance, may be configured as a curved electronic ink display that is integrated into a surface of the housing 202 of the stylus 116. As illustrated, the display device 116 in this example includes a display indicating that “Liam” was identified in this example. Such feedback may also take the form of auditory or vibrotactile output.

The display device 212 may also be used to support a variety of other functionality. For instance, the display device 212 may be used to provide feedback describing a state of the stylus 116. Such a display device 116 could also be used to display branding of the stylus 116, advertisements, provide feedback of the current mode (e.g., a current drawing state such as pen, crayon, spray can, highlighter), touchable links (e.g., through implementation as a touchscreen), controls, designs, skins to customize a look and feel of the stylus, messages, alerts, files, links to web, photos, clipboard material, and so forth. For instance, the control module 204 of the stylus 116 may include memory to support a cut and paste operation between different computing devices. A variety of other display devices that may be incorporated within the stylus 116 are also contemplated, such as a projector that is usable to project an image on a surface outside of the stylus 116. A variety of other examples are also contemplated, further discussion of which may be found in relation to the following figure.

FIG. 3 depicts a system 300 in an example implementation in which the stylus 116 is used to support a computing environment that is executable using different devices. The system 300 includes the computing device 102 and stylus 116 of FIG. 1 along with a second computing device 302 with which the user interacts at a later point in time using a stylus, as indicated by the arrow in the figure.

In this example, a user initially uses a stylus 116 to login to the computing device by writing the user's name 304 (e.g., Eleanor) on the display device 108. As previously mentioned, the computing device 102 and/or the stylus 116 may use this handwriting along with other characteristics of the user such as biometric data, how the stylus 116 is held, an orientation of the stylus 116 in three dimensional space, and so on to identify a user of the stylus.

The stylus 116 is then shown as making changes to an image 306 displayed as part of a photo-editing application. User information 308 that describes this state is illustrated as being stored at a service provider 122 that is accessible to the computing device 102 via the network 124. Other examples are also contemplated, however, such as through storage of this user information 308 in the stylus 116 itself, within the computing device 102, and so on.

A user is then illustrated as using the stylus 116 to login to the second computing device 302 by writing the user's name 304 as before. Responsive to identification of the user, the second computing device 302 may be configured to obtain the user information 308 automatically and without further user intervention, such as from the service provider 122, the stylus 116 itself, and so on. This user information 308 may then be used by the second computing device 302 to return to the state of interaction with the computing device 102, such as interaction with the image 306 in the photo editing application. Thus, this technique may support a computing environment that may be “carried” between computing devices by the user as desired.

A variety of other implementations are also contemplated. For example, the computing device 102 and stylus 116 may expose an amount of information based on proximity. When the stylus 116 is within wireless communication range with the computing device 102, for instance, the computing device 102 may be configured to view the user's calendar. When the stylus 116 is used to tap a display device 108 of the computing device 102, however, full access to the user's calendar may be granted, such as to make, change, and delete appointments. A variety of other examples are also contemplated in which a level of content access is granted based on corresponding levels of proximity between the stylus 116 and a device.

Example Procedures

The following discussion describes stylus computing environment techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the systems 200, 300 of FIGS. 2 and 3, respectively.

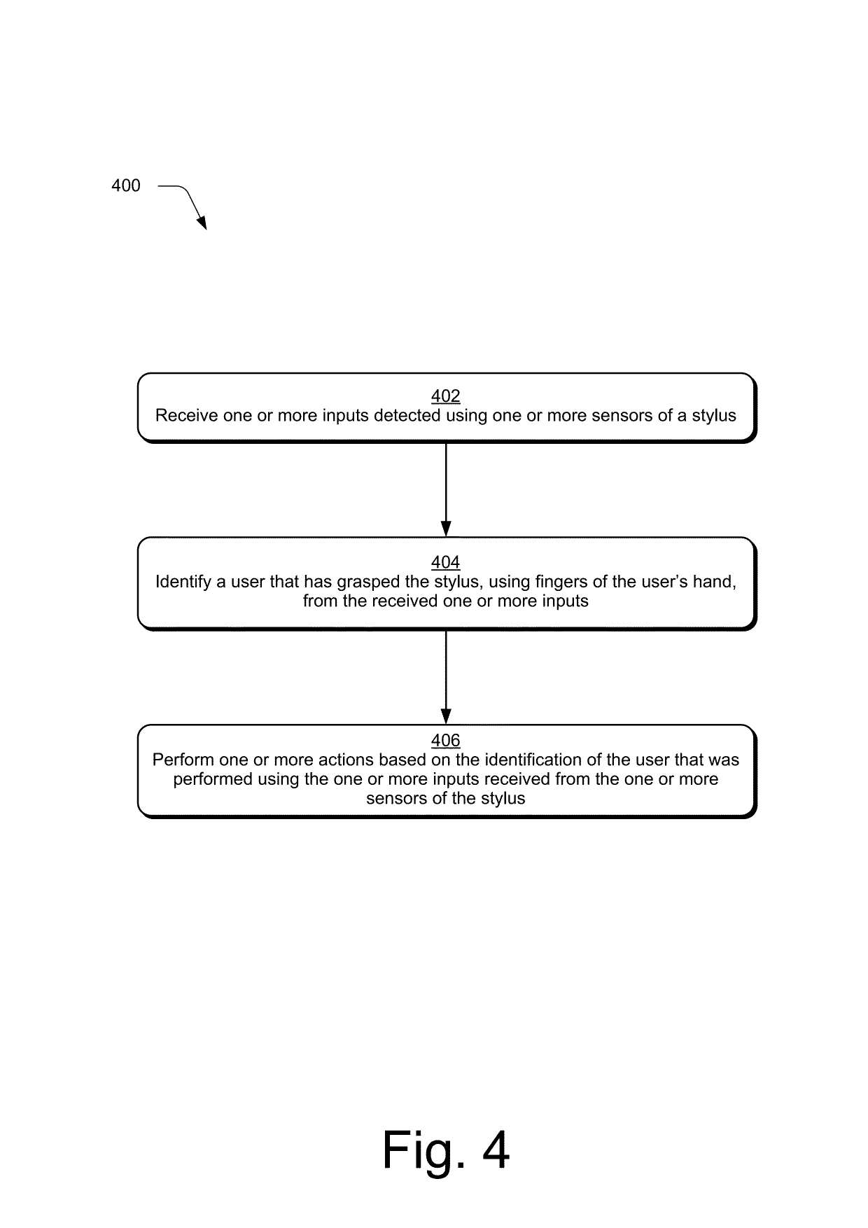

FIG. 4 depicts a procedure 400 in an example implementation in which a user is identified using a stylus. One or more inputs are detected using one or more sensors of a stylus (block 402). The sensors 210, for instance, may be configured to detect biometric characteristics of a user, how the stylus 116 is held by a user, an orientation of the stylus 116 in three-dimensional space, “what” the stylus is “looking at” using a camera disposed in a tip of the stylus 116, how the stylus 116 is used (e.g., to detect handwriting), the GUID attached to the stylus and/or displays that the stylus is in contact with or proximal to, and so forth.

A user that has grasped the stylus, using fingers of the user's hand, is identified from the received one or more inputs (block 404). Continuing with the previous example, a wide variety of different types of information may be obtained from the sensors 210. This information may then be leveraged individually and/or in combination to identify a user, such as at the stylus 116 itself, a computing device 102 with which the stylus 116 is in communication, remotely as part of one or more network services of a service provider 122, and so on.

One or more actions are performed based on the identification of the user that was performed using the one or more inputs received from the one or more sensors of the stylus (block 406). As previously described, these actions may be performed at the stylus 116 itself, at the computing device 102, involve use of a network service of the service provider 122, and so on as previously described.

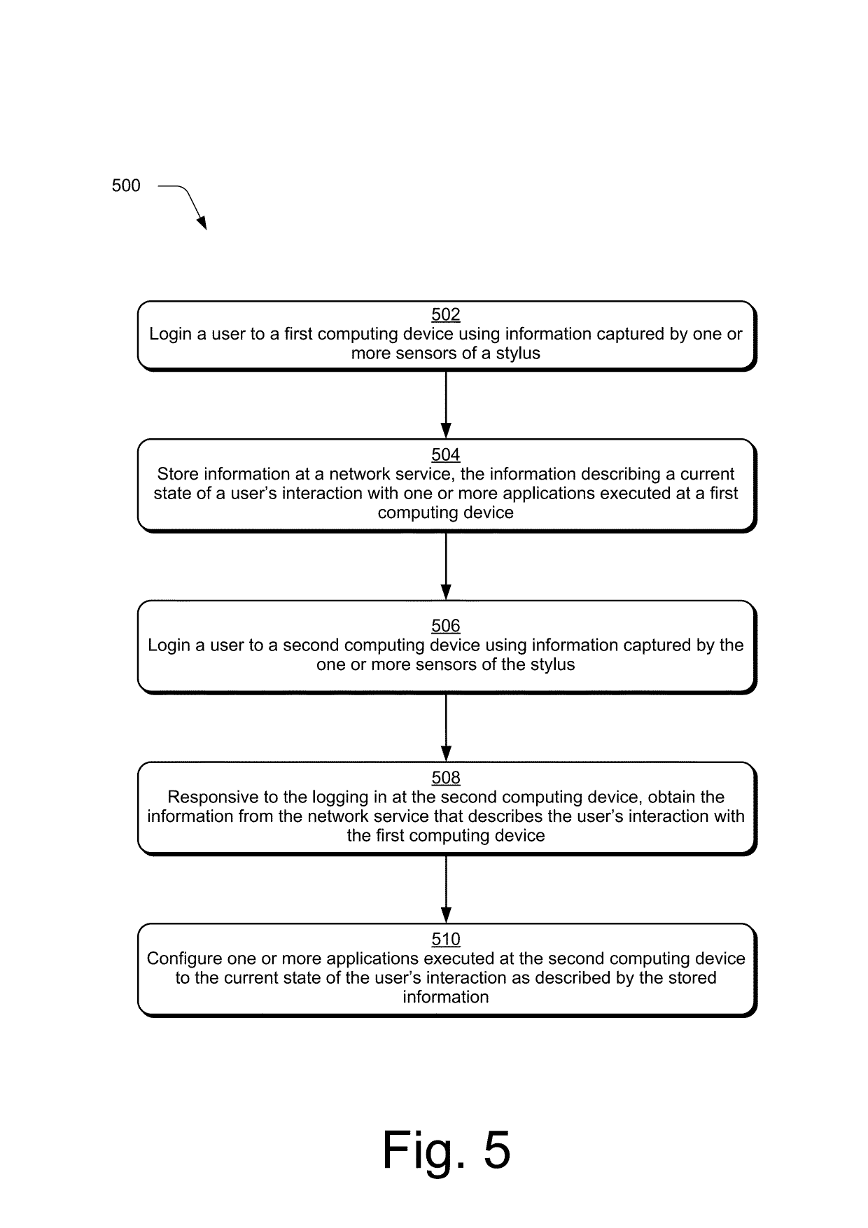

FIG. 5 depicts a procedure 500 in an example implementation in which a network service is leveraged using a stylus to provide a continued computing environment. A user is logged into a first computing device using information captured by one or more sensors of a stylus (block 502). As before, this may include a wide variety of information that may be used to uniquely identify a user, such as to collect a user's handwriting along with biometric characteristics of the user as illustrated in conjunction with computing device 102 in the example system 300 of FIG. 3.

Information is stored at a network service, the information describing a current state of a user's interaction with one or more applications executed at a first computing device (block 504). User information 308, in this example, may include a current state of a user's interaction with an application, which may be communicated automatically and without additional user interaction as the user in logged into the computing device 102.

The user is logged into a second computing device using information captured by the one or more sensors of the stylus (block 506). The user, for instance, may repeat the signature on another computing device 304 as shown in FIG. 3.

Responsive to the logging in at the second computing device, the information is obtained by the second computing device from the network service that describes the user's interaction with the first computing device and one or more applications executed at the second computing device are configured to the current state of the user's interaction as described by the stored information (block 508). This information, for instance, may be fetched by the computing device 302 automatically and without user intervention such that a user can “continue where they left off” regarding the interaction with the computing device 102. In this way, a user is provided with a seamless computing device that may be supported through unique identification of the user.

Example System and Device

FIG. 6 illustrates an example system 600 that includes the computing device 102 as described with reference to FIG. 1. The example system 600 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 600, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 102 may assume a variety of different configurations, such as for computer 602, mobile 604, and television 606 uses. Each of these configurations includes devices that may have generally different constructs and capabilities, and thus the computing device 102 may be configured according to one or more of the different device classes. For instance, the computing device 102 may be implemented as the computer 602 class of a device that includes a personal computer, desktop computer, a multi-screen computer, laptop computer, netbook, and so on.

The computing device 102 may also be implemented as the mobile 604 class of device that includes mobile devices, such as a mobile phone, portable music player, portable gaming device, a tablet computer, a multi-screen computer, and so on. The computing device 102 may also be implemented as the television 606 class of device that includes devices having or connected to generally larger screens in casual viewing environments. These devices include televisions, set-top boxes, gaming consoles, and so on. The techniques described herein may be supported by these various configurations of the computing device 102 and are not limited to the specific examples the techniques described herein.

The cloud 608 includes and/or is representative of a platform 610 for content services 612. The platform 610 abstracts underlying functionality of hardware (e.g., servers) and software resources of the cloud 608. The content services 612 may include applications and/or data that can be utilized while computer processing is executed on servers that are remote from the computing device 102. Content services 612 can be provided as a service over the Internet and/or through a subscriber network, such as a cellular or Wi-Fi network.

The platform 610 may abstract resources and functions to connect the computing device 102 with other computing devices. The platform 610 may also serve to abstract scaling of resources to provide a corresponding level of scale to encountered demand for the content services 612 that are implemented via the platform 610. Accordingly, in an interconnected device embodiment, implementation of functionality of the functionality described herein may be distributed throughout the system 600. For example, the functionality may be implemented in part on the computing device 102 as well as via the platform 610 that abstracts the functionality of the cloud 608.

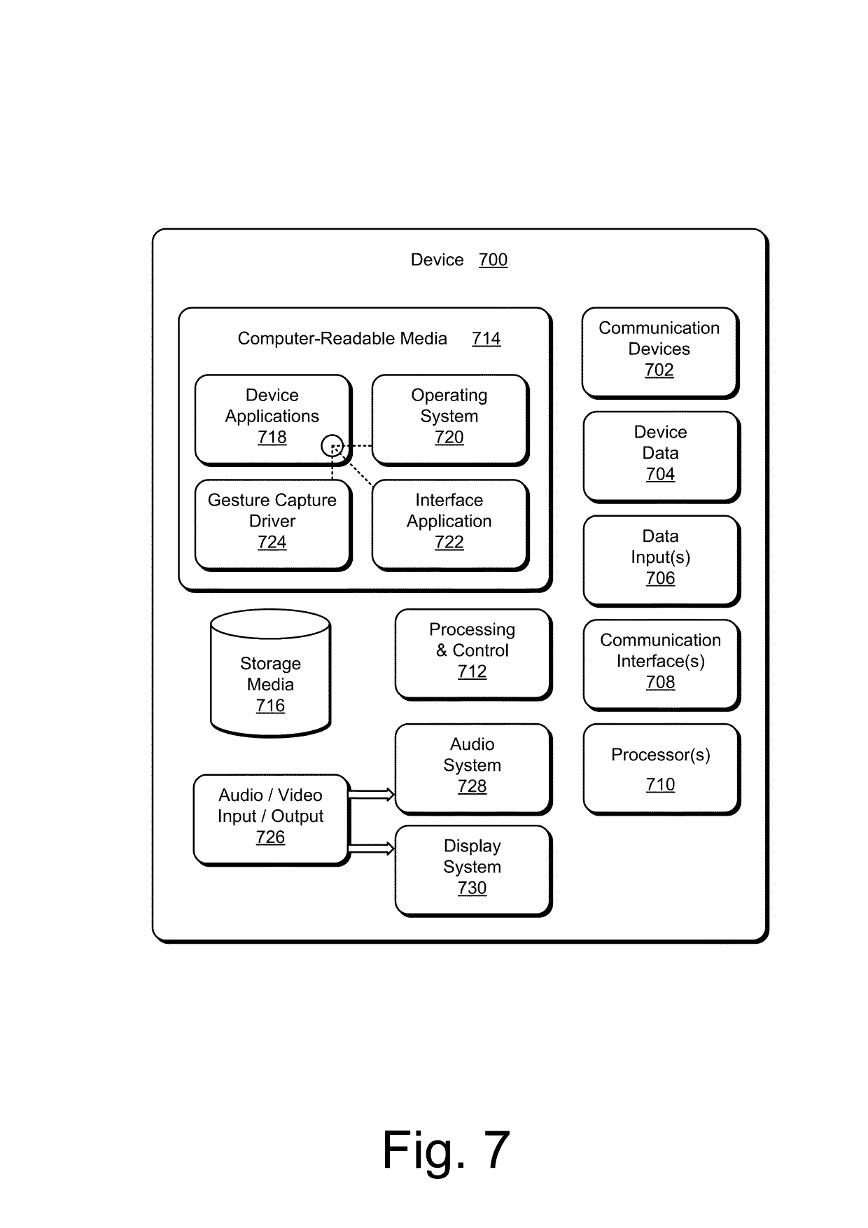

FIG. 7 illustrates various components of an example device 700 that can be implemented as any type of computing device as described with reference to FIGS. 1, 2, and 6 to implement embodiments of the techniques described herein. Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable instructions to control the operation of device 700 and to implement embodiments of the techniques described herein. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager (e.g., a control application, software application, signal processing and control module, code that is native to a particular device, a hardware abstraction layer for a particular device, etc.). The device applications 718 also include any system components or modules to implement embodiments of the techniques described herein. In this example, the device applications 718 include an interface application 722 and an input/output module 724 that are shown as software modules and/or computer applications. The input/output module 724 is representative of software that is used to provide an interface with a device configured to capture inputs, such as a touchscreen, track pad, camera, microphone, and so on. Alternatively or in addition, the interface application 722 and the input/output module 724 can be implemented as hardware, software, firmware, or any combination thereof. Additionally, the input/output module 724 may be configured to support multiple input devices, such as separate devices to capture visual and audio inputs, respectively.

Device 700 also includes an audio and/or video input-output system 726 that provides audio data to an audio system 728 and/or provides video data to a display system 730. The audio system 728 and/or the display system 730 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 728 and/or the display system 730 are implemented as external components to device 700. Alternatively, the audio system 728 and/or the display system 730 are implemented as integrated components of example device 700.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by one or more modules at least partially in hardware, the method comprising:
receiving one or more inputs detected using one or more sensors of a stylus;
identifying a user that has grasped the stylus, using fingers of the user's hand, from the received one or more inputs; and
performing one or more actions based on the identification of the user that was performed using the one or more inputs received from the one or more sensors of the stylus

2. A method as described in claim 1, wherein the receiving, the identifying, and the performing are performed by the one or more modules as part of a computing device that is communicatively coupled to the stylus.

3. A method as described in claim 1, wherein the receiving, the identifying, and the performing are performed by the one or more modules disposed within a housing of the stylus.

4. A method as described in claim 1, wherein the receiving includes detecting one or more biometric characteristics of the user using the sensors of the stylus.

5. A method as described in claim 1, wherein the receiving includes detecting handwriting of the user of the stylus using the one or more sensors.

6. A method as described in claim 5, wherein the detecting is performed by a computing device that is communicatively coupled to the stylus and upon which the handwriting is received through movement of the stylus.

7. A method as described in claim 1, wherein the receiving includes detecting one or more orientations of the stylus using the one or more sensors when grasped by the fingers of the user.

8. A method as described in claim 1, wherein the performing of the one or more actions includes outputting the identification of the user on a display device of the stylus.

9. A method as described in claim 1, wherein the performing of the one or more actions includes obtaining one or more configuration settings of the identified user.

10. A method as described in claim 9, wherein the one or more configuration settings include a description of a state of the user's interaction with one or more applications, the state transferable from one computing device to another.

11. A method as described in claim 10, wherein the state supports a cut and paste operation between two different computing devices using the stylus.

12. A method as described in claim 1, wherein the performing of the one or more actions includes communicating the identification from the stylus to a computing device, thereby causing the computing device to obtain one or more configuration settings of the identified user that are usable to configure a user interface of the computing device.

13. A method as described in claim 1, wherein the performing of the one or more actions includes communicating the identification from the stylus to a computing device, thereby causing the computing device to authenticate the user for interaction with the computing device.

14. A method as described in claim 13, wherein the communicating of the identification from the stylus to the computing device further causes the computing device to fetch data over a remote network connection that relates to the user responsive to authentication of the user.

15. A method as described in claim 1, wherein the receiving is performed responsive to detection by a computing device of a gesture performed by the stylus in conjunction with the computing device.

16. A stylus comprising:
a housing configured to be graspable using fingers of a user's hand;
one or more sensors; and
one or more modules disposed within the housing and implemented at least partially in hardware and configured to process data obtained from the one or more sensors to identify the user and provide an output indicating the identification of the user.

17. A stylus as described in claim 16, wherein the output is a display of the identification of the user on a display device incorporated within the housing or the output is a communication that is communicated to a computing device with which the stylus is configured to interact.

18. A stylus as described in claim 16, wherein the one or more sensors are configured to detect an orientation of the stylus, handwriting of a user of the stylus, or fingerprints of the fingers of the user's hand used to grasp the stylus.

19. A method comprising:
logging in a user to a first computing device using information captured by one or more sensors of a stylus;
storing information at a network service, the information describing a current state of a user's interaction with one or more applications executed at a first computing device;
logging in the user to a second computing device using information captured by the one or more sensors of the stylus;
responsive to the logging in at the second computing device, obtaining the information from the network service that describes the user's interaction with the first computing device; and
configuring one or more applications executed at the second computing device to the current state of the user's interaction as described by the stored information.

20. A method as described in claim 19, wherein the logging in to the first or second computing device is based at least in part on information captured by the one or more sensors of the stylus that describes an orientation of the stylus in three-dimensional space, one or more fingerprints detected by the one or more sensors, or handwriting performed by the stylus in conjunction with the first computing device.
